(19) United States
(12) Patent Application Publication
(10) Pub. No.: US 2023/0413093 A1
(43) Pub. Date: Dec. 21, 2023

(54) MEASUREMENT METHOD AND APPARATUS

(71) Applicant: VIVO MOBILE COMMUNICATION CO., LTD., Dongguan (CN)

(72) Inventor: Zhonghuang LI, Dongguan (CN)

(73) Assignee: VIVO MOBILE COMMUNICATION CO., LTD., Dongguan (CN)

(21) Appl. No.: 18/229,737

(22) Filed: Aug. 3, 2023

Related U.S. Application Data
(63) Continuation of application No. PCT/CN2022/074261, filed on Jan. 27, 2022.

(30) Foreign Application Priority Data
Feb. 4, 2021 (CN) 202110158877.3

(51) Int. Cl. H04W 24/10

(52) U.S. Cl. CPC H04W 24/10

(57) ABSTRACT

This application discloses a measurement method and apparatus. The measurement method includes: receiving measurement configuration information sent by a network device, where the measurement configuration information includes a first measurement gap period and an identity of a target cell; obtaining N pieces of measurement result information when an electronic device executes a service by using a network of a first cell and the measurement configuration information satisfies a first preset condition; and increasing the first measurement gap period to obtain a target measurement gap period, and measuring the target cell based on the target measurement gap period when the N pieces of the measurement result information satisfy a second preset condition.

### CROSS-REFERENCE TO RELATED APPLICATION

This application is a continuation of International Application No. PCT/CN2022/074261, filed Jan. 27, 2022, which claims priority to Chinese Patent Application No. 202110158877.3, filed Feb. 4, 2021. The entire contents of each of the above-referenced applications are expressly incorporated herein by reference.

### TECHNICAL FIELD

This application relates to the field of communications technologies, and in particular, to a measurement method and apparatus.

### BACKGROUND

Currently, in a non-standalone (NSA) architecture network of a 5G network, in a case that the electronic device accesses the LTE cell, an electronic device can adjust a frequency of a receiver of the electronic device from a frequency of an LTE cell to a frequency of a to-be-measured NR cell, to measure the to-be-measured NR cell. If the to-be-measured NR cell does not satisfy a condition for reporting, the electronic device can restore the frequency of the receiver to the frequency of the LTE cell. The above steps are periodically performed based on the measurement gap period until a certain NR cell satisfies the condition for reporting. In this way, the electronic device can perform a registration process for the certain NR cell so that 5G services are accessed. However, there may be a possibility that the electronic device may need to

transmit service data by using a network of the LTE cell, and the electronic device can only transmit the service data after the frequency of the receiver is restored to the frequency of the LTE cell. Therefore, the electronic device needs to wait multiple times based on the measurement gap period for the electronic device to restore the frequency of the receiver to the frequency of the LTE cell to periodically transmit the service data until a certain NR cell satisfies the condition for reporting.

This results in high delay for the electronic device to transmit the service data.

### SUMMARY

Embodiments of this application are intended to provide a measurement method and apparatus.

According to a first aspect, the embodiments of this application provide a measurement method. The measurement method includes: receiving measurement configuration information sent by a network device, where the measurement configuration information includes: a first measurement gap period and an identity of a target cell; obtaining N pieces of measurement result information in a case that an electronic device executes a service by using a network of a first cell and the measurement configuration information satisfies a first preset condition, where the N pieces of the measurement result information are result information of N measurements performed by the electronic device on the target cell before the measurement configuration information is received, and N is a positive integer; and increasing the first measurement gap period to obtain a target measurement gap period, and measuring the target cell based on the target measurement gap period in a case that the N pieces of the measurement result information satisfy a second preset condition.

According to a second aspect, the embodiments of this application provide a measurement apparatus. The measurement apparatus includes a receiving module, an obtaining module, an adjustment module, and a measurement module. The receiving module is configured to receive measurement configuration information sent by a network device, and the measurement configuration information includes a first measurement gap period and an identity of a target cell. The obtaining module is configured to obtain N pieces of measurement result information in a case that the measurement apparatus executes a service by using a network of a first cell and the measurement configuration information received by the receiving module satisfies a first preset condition. The N pieces of the measurement result information are result information of N measurements performed by the measurement apparatus on the target cell before the measurement configuration information is received, and N is a positive integer. The adjustment module is configured to increase the first measurement gap period to obtain a target measurement gap period in a case that the N pieces of the measurement result information obtained by the obtaining module satisfy a second preset condition. The measurement module is configured to measure the target cell based on the target measurement gap period obtained after the adjustment module increases the first measurement gap period.

According to a third aspect, the embodiments of this application provide an electronic device. The electronic device includes a processor, a memory, and a program or an instruction stored in the memory and capable of running on the processor. When the program or the instruction is executed by the processor, the steps of the method according to the first aspect are implemented.

According to a fourth aspect, the embodiments of this application provide a readable storage medium. The readable storage medium stores a program or an instruction, and when the program or the instruction is executed by a processor, the steps of the method according to the first aspect are implemented.

According to a fifth aspect, the embodiments of this application provide a chip. The chip includes a processor and a communications interface, the communications interface is coupled to the processor, and the processor is configured to run a program or an instruction, to implement the method according to the first aspect.

In the embodiments of this application, the electronic device can receive the measurement configuration information sent by the network device, and in a case that the electronic device executes a service by using the network of the first cell and the measurement configuration information satisfies the first preset condition, the electronic device can obtain the N pieces of the measurement result information of the N measurements that have been performed on the target cell corresponding to the measurement configuration information (that is, before the electronic device receives the measurement configuration information). In addition, in a case that the N pieces of the measurement result information satisfy the second preset condition, the electronic device can increase the first measurement gap period in the measurement configuration information to obtain the target measurement gap period, so as to measure the target cell based on the target measurement gap period. In a case that the electronic device can execute a service by using the network of the first cell and the measurement configuration information satisfies the first preset condition, because the electronic device can, based on the measurement configuration information, determine that the electronic device can transmit service data by using the network of the first cell and the network signal of the target cell may be poor, the electronic device can obtain the measurement result information of the N measurements that have been performed on the target cell and determine whether the measurement result information of the N measurements satisfies the second preset condition, so as to determine whether the network signal of the target cell is poor. In addition, in a case that the network signal of the target cell is poor, the electronic device can increase the first measurement gap period and measure the target cell based on the target measurement gap period. In this way, in a case that the target cell does not satisfy the condition for reporting in the measurement configuration information, the electronic device can interrupt the transmission of the service data after the frequency of the receiver is restored to the frequency of the first cell and the service data is transmitted by the network of the first cell for a long time. Therefore, in a case that the network signal of the target cell is poor, time for the electronic device to transmit the service data can be increased. In this case, the delay for the electronic device to transmit the service data can be reduced.

### BRIEF DESCRIPTION OF DRAWINGS

FIG. 1 is a schematic diagram of an architecture of a measurement system according to the embodiments of this application;

FIG. 2 is a schematic diagram of a network architecture corresponding to NSA;

FIG. 3 is a first schematic diagram of a measurement method according to the embodiments of this application;

FIG. 4 is a second schematic diagram of a measurement method according to the embodiments of this application;

FIG. 5 is a third schematic diagram of a measurement method according to the embodiments of this application;

FIG. 6 is a fourth schematic diagram of a measurement method according to the embodiments of this application;

FIG. 7 is a schematic structural diagram of a measurement apparatus according to the embodiments of this application;

FIG. 8 is a schematic structural diagram of an electronic device according to

the embodiments of this application; and

FIG. 9 is a schematic diagram of hardware of an electronic device according to the embodiments of this application.

### DETAILED DESCRIPTION

The following describes the technical solutions in embodiments of this application with reference to the accompanying drawings in the embodiments of this application. Apparently, the described embodiments are some rather than all of the embodiments of this application. All other embodiments obtained by a person of ordinary skill in the art based on the embodiments of this application without creative efforts shall fall within the protection scope of this application.

The terms “first”, “second”, and the like in this specification and claims of this application are used to distinguish between similar objects instead of describing a specific order or sequence. It should be understood that the data used in this way is interchangeable in appropriate circumstances, so that the embodiments of this application can be implemented in other orders than the order illustrated or described herein. In addition, objects distinguished by “first” and “second” are usually of one category, and a quantity of objects is not limited. For example, a first object may mean one or more objects. In addition, “and/or” in the specification and claims represents at least one of connected objects. Symbol “/” in the specification generally represents an “or” relationship between associated objects.

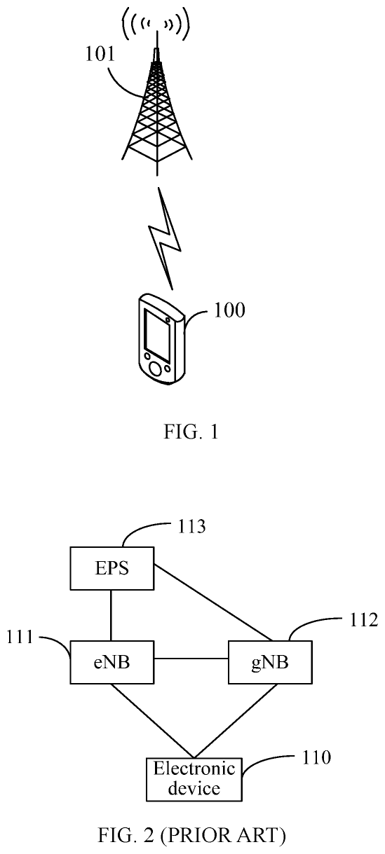

FIG. 1 is a structural diagram of an architecture of a measurement system according to the embodiments of this application. As shown in FIG. 1, the measurement system includes an electronic device 100 and a network device 101. The electronic device 100 may be a mobile communications device, for example, a mobile phone, a tablet computer (TPC), a laptop computer (LC), a personal digital assistant (PDA), a mobile Internet device (MID), or a wearable device (WD). It should be noted that a specific type of the electronic device 100 is not limited in the embodiments of this application. The network device 101 may be a 5G network device (for example, a gNB or a 5G NR NB), a 4G network device (for example, an eNB), a 3G network device (for example, an NB), a network device in a later evolved communications system, or the like. It should be noted that a specific type of the network device 101 is not limited in the embodiments of this application.

Before the technical solution in the embodiments of this application is described in detail, an NSA network architecture of a 5G network defined by 3GPP is briefly described.

FIG. 2 is a schematic diagram of a network architecture corresponding to NSA. As shown in FIG. 2, in the NSA network architecture, an electronic device 110 may be connected to both eNB111 and gNB112. There is an interface between eNB111 and gNB112 for transmitting distributed data. For example, an evolved packet system (EPS) 113 distributes a portion of downlink data to the gNB112 by using the eNB111, and the downlink data of the eNB111 and the gNB112 is aggregated in the electronic device 110.

The following describes in detail the measurement method provided in the embodiments of this application through embodiments and application scenarios thereof with reference to the accompanying drawings.

The measurement method provided in the embodiments of this application may be applied to a scenario in which an electronic device measures a cell.

It is assumed that in an NSA architecture of a 5G network, an electronic device needs to transmit service data by using a network. In related technologies, the electronic device can first search for an LTE cell and then determine whether the LTE cell supports NSA based on EN-DC (E-UTRA-NR Dual Connectivity) indication of the LTE cell. If the LTE cell supports NSA, the electronic device carries indication of dual connectivity with new radio supported (DCNR) in an attach request message. If the LTE cell allows the electronic device to preform dual connectivity, the network device notifies the electronic device by using an attach accept message and sends measurement configuration information to the electronic device. In this case, the electronic device can first transmit the service data by using a network of the LTE cell, activate a 5G modem based on the measurement configuration information, and then interrupt transmission of the service data. In addition, a frequency of a receiver of the electronic device can be adjusted from a frequency of the LTE cell to a frequency of a to-be-measured NR cell, so as to measure the to-be-measured NR cell. If the electronic device is located in an area on an edge of the NR cell, there may be a case in which a network signal of the to-be-measured NR cell is poor, which means that all to-be-measured NR cells do not satisfy a condition for reporting. In this way, the electronic device can restore the frequency of the receiver to the frequency of the LTE cell and continue to transmit the service data by using the network of the LTE cell. Then, after the measurement gap period in the measurement configuration information, the electronic device interrupts the transmission of the service data and adjusts the frequency of the receiver of the electronic device from the frequency of the LTE cell to the frequency of the to-be-measured NR cell, so as to measure the to-be-measured NR cell again. The electronic device performs these similar steps until a certain NR cell satisfies the condition for reporting so that the electronic device can send a measurement report to the network device, and the network device can activate a secondary cell group (SCG) cell (that is, a certain NR cell) based on the measurement report. However, because the electronic device needs to wait for multiple times based on the measurement gap period when the electronic device restores the frequency of the receiver to the frequency of the LTE cell to periodically transmit the service data until a certain NR cell satisfies the condition for reporting, there is higher delay for the electronic device to transmit the service data.

However, in the embodiments of this application, the electronic device can determine: whether the electronic device transmits the service data by using the network of the LTE cell based on the measurement configuration information; whether an identity of a to-be-measured cell in the measurement configuration information matches an identity of the to-be-measured NR cell in the first N pieces of the measurement configuration information (that is, N pieces of the measurement configuration information received by the electronic device before the measurement configuration information is received); and whether a duration between a receiving moment of the measurement configuration information and a receiving moment of the first N pieces of the measurement configuration information is smaller than or equal to a preset duration. In this way, the electronic device can determine that the electronic device transmits the service data by using the network of the LTE cell, and obtain the first N pieces of measurement location information (that is, location information of the electronic device when the electronic device performs N measurements on the to-be-measured NR cell before the measurement configuration information is received) and N network signal parameters (that is, network signal parameters of the to-be-measured NR cell obtained after the electronic device performs N measurements on the to-be-measured NR cell before the measurement configuration information is received), so that the electronic device can determine whether a location change of the electronic device is smaller than or equal to a certain threshold based on the N pieces of measurement location information, and whether all the N network signal parameters are smaller than or equal to another threshold. In this way, if the location change of the electronic device is smaller than or equal to the certain threshold, and all the N network signal parameters are smaller than or equal to the another threshold, it can be considered that the electronic device has measured the to-be-measured NR cell multiple times, and the location change of the electronic device is small, and the network signal of the to-be-measured NR cell is poor. In other words, the electronic device may be located in an area on the edge of the NR cell. In this case, the electronic device can increase the measurement gap period, and measure the to-be-measured NR cell based on the measurement gap period after the increase. It may be understood that the measurement gap period after the increase is greater than the measurement gap period before the increase, that is, in a case that the network signal of the to-be-measured NR cell is poor, a duration in which the electronic device transmits the service data after the measurement gap period is increased is greater than a duration in which the electronic device transmits the service data before the measurement gap period is increased. Therefore, the delay for the electronic device to transmit the service data can be reduced.

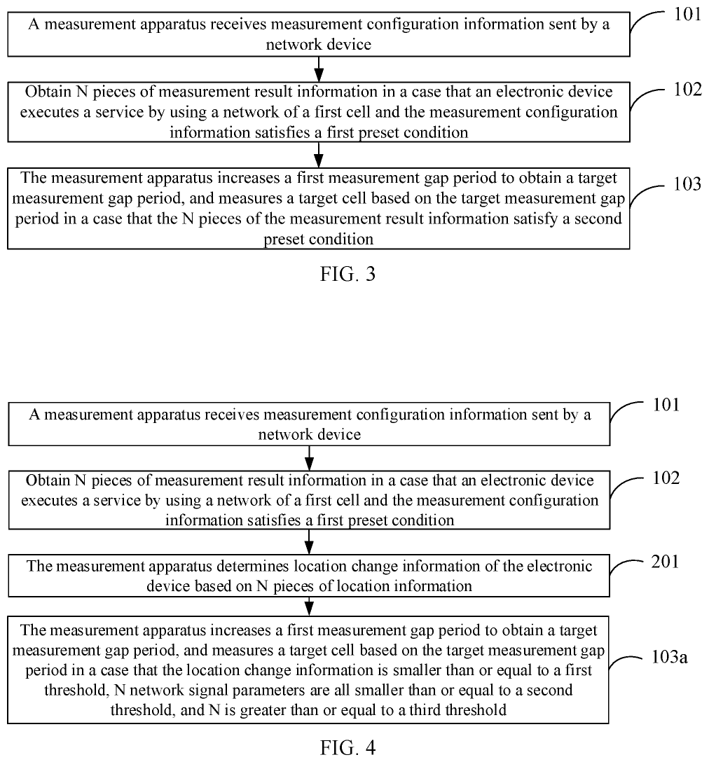

FIG. 3 is a flowchart of a measurement method according to the embodiments of this application. As shown in FIG. 3, the measurement method provided in the embodiments of this application may include the following step 101 to step 103.

Step 101: A measurement apparatus receives measurement configuration information sent by a network device.

In the embodiments of this application, in a case that the measurement apparatus is in a network searching state, the measurement apparatus can send a connection establishment request to a network device. The connection establishment request is used to request an establishment of a connection with a cell that supports NSA (for example, a first cell in the following embodiment), so that the network device can send a 5G capability query message to the measurement apparatus based on the connection establishment request. The 5G capability query message is used to request the measurement apparatus to send wireless access capability information of the measurement apparatus in certain radio access technologies (RAT). In this case, the measurement apparatus can send a measurement apparatus capability information (UE capability information) message to the network device based on the 5G capability query message. Therefore, the network device can determine whether the measurement apparatus supports 5G based on the measurement apparatus capability information message. In addition, in a case that the measurement apparatus supports 5G, the network device sends a connection establishment response to the measurement apparatus, and the connection establishment response is used to indicate a successful connection establishment. In addition, the network device sends the measurement configuration information to the measurement apparatus, so that the measurement apparatus can receive the measurement configuration information.

It should be noted that the “network searching state” can be understood as a state in which the measurement apparatus searches a network before obtaining a network service, or a state in which the measurement apparatus searches a network before connecting to the network. For example, the “network searching state” may be a state in which the measurement apparatus is turned on again, or a state of the measurement apparatus when an airplane mode is turned off after the airplane mode is turned on.

In the embodiments of this application, the measurement configuration information includes a first measurement gap period and an identity of a target cell.

It should be noted that the foregoing “measurement gap period” may be understood as a time interval between a moment after the measurement apparatus performs an inter-frequency measurement and a moment when the measurement apparatus performs the inter-frequency measurement again if a to-be-measured cell does not satisfy the condition for reporting.

In the embodiments of this application, the identity of the target cell may be physical cell identities (PCI) of the target cell.

In the embodiments of this application, the target cell may be a secondary cell or a non-serving cell of the measurement apparatus.

Further, in the embodiments of this application, the target cell may be: an NR cell.

Step 102: Obtain N pieces of measurement result information in a case that the measurement apparatus executes a service by using a network of a first cell and the measurement configuration information satisfies a first preset condition.

In the embodiments of this application, the first cell may be a cell that allows the measurement apparatus to perform dual connectivity, and the first cell may be a master cell or a serving cell of the measurement apparatus.

Further, in the embodiments of this application, the first cell may be: an LTE cell.

In the embodiments of this application, the measurement apparatus can detect an application that runs in the background of the measurement apparatus to determine whether the measurement apparatus performs a service by using a network of the first cell. In some embodiments, the measurement apparatus can detect a current Internet speed of the measurement apparatus to determine whether the measurement apparatus performs a service by using the network of the first cell.

Further, in the embodiments of this application, in a case that a quantity of applications that run in the background of the measurement apparatus and that use a data network is greater than or equal to a fifth threshold (for example, 3), the measurement apparatus can determine that the measurement apparatus executes a service by using the network of the first cell. In a case that a current Internet speed is greater than or equal to a sixth threshold (for example, 100 KB/s (kilobits/second)), the measurement apparatus can determine that the measurement apparatus executes a service by using the network of the first cell.

Further, in the embodiments of this application, the fifth threshold and the sixth threshold may be preset thresholds stored in a memory medium of the measurement apparatus.

In the embodiments of this application, the first preset condition may include at least one of the following:
an identity of the target cell in the measurement configuration information matches identities of N cells; or
a duration between a receiving moment of the measurement configuration information and a receiving moment of N pieces of the measurement configuration information is smaller than or equal to a preset duration.

It should be noted that the “identities of N cells” may be understood as identities of cells corresponding to N measurements performed by the measurement apparatus before the measurement configuration information is received. The “N pieces of the measurement configuration information” may be understood as measurement configuration information received by the measurement apparatus before the measurement configuration information is received.

It may be understood that in a case that the measurement apparatus is attached to the first cell, the network device can send a first piece of measurement configuration information to the measurement apparatus, so that the measurement apparatus can measure a cell indicated by an identity of a cell included in the first piece of measurement configuration information based on the first piece of measurement configuration information (that is, a measurement is performed periodically according to a measurement gap period in the first piece of measurement configuration information). If the cell indicated by the identity of the cell included in the first piece of measurement configuration information does not satisfy the condition for reporting, the measurement apparatus does not send a measurement report to the network device, so that the network device can send a deletion instruction to the measurement apparatus after a certain period of time. The deletion instruction is used to indicate that the measurement apparatus deletes the first measurement configuration information and a second piece of measurement configuration information is sent to the measurement apparatus again, so that the measurement apparatus can measure a cell indicated by an identity of a cell included in the second piece of measurement configuration information again based on the second piece of measurement configuration information (that is, a measurement is performed periodically according to a measurement gap period in the second piece of measurement configuration information). Similar steps are performed until the network device sends an Nth piece of measurement configuration information to the measurement apparatus. In this way, the measurement apparatus can copy each piece of measurement configuration information in the memory medium of the measurement apparatus after each piece of measurement configuration information is received, so that the measurement apparatus can determine whether the measurement configuration information (that is, the measurement configuration information received by the measurement apparatus in step 101) satisfies the first preset condition based on each piece of measurement configuration information.

In the embodiments of this application, the measurement apparatus can detect the N pieces of the measurement configuration information to obtain identities of N cells, so that the measurement apparatus can determine whether the identity of the target cell in the measurement configuration information matches the identities of the N cells (for example, the identity of the target cell in the measurement configuration information is the same as the identities of the N cells). In some embodiments, the measurement apparatus can detect the measurement configuration information and the N pieces of measurement configuration information separately to obtain a receiving moment of the measurement configuration information and a receiving time of the N pieces of measurement configuration information. Therefore, the measurement apparatus can determine whether a duration between the receiving moment of the measurement configuration information and the receiving moment of the N pieces of the measurement configuration information is smaller than or equal to a preset duration (for example, 60 seconds).

In the embodiments of this application, if the measurement apparatus executes a service by using the network of the first cell and the measurement configuration information satisfies the first preset condition, it can be considered that the measurement apparatus needs to transmit service data by using the network, and the measurement apparatus measures a same cell (that is, the target cell) more frequently (that is, the measurement apparatus may be located in an area on the edge of the target cell). Therefore, the measurement apparatus can obtain the N pieces of the measurement result information to further determine whether the measurement apparatus is located in an area on the edge of the target cell (that is, whether a network signal of the target cell is poor).

In the embodiments of this application, the N pieces of the measurement result information are result information of the N measurements performed by the measurement apparatus on the target cell before the measurement configuration information is received, and N is a positive integer.

In the embodiments of this application, for each of the N pieces of the measurement result information, one piece of measurement result information may include at least one of the following: one piece of location information or one network signal parameter. The one piece of location information is used to indicate a location of the measurement apparatus when one measurement is performed on the target cell, and the one network signal parameter is a network signal parameter of the target cell that is obtained from one measurement that is performed on the target cell.

Further, in the embodiments of this application, for each of the N pieces of the measurement result information, one piece of location information in one piece of measurement result information may be average location information of at least one piece of location information obtained from a measurement (that is, a periodic measurement) performed on the target cell, and one network signal parameter may be an average network signal parameter of at least one network signal parameter obtained from one measurement (that is, a periodic measurement) performed on the target cell.

In some embodiments, one network signal parameter may include at least one of the following: a reference signal receiving power (RSRP) value, a reference signal receiving quality (RSRQ) value, or a signal-to-noise ratio of a reference signal.

In the embodiments of this application, for each of the N pieces of the measurement result information, after the measurement apparatus performs one measurement on the target cell, the measurement apparatus can store one piece of measurement result information in the memory medium of the measurement apparatus to store N pieces of measurement result information, so that the measurement apparatus can obtain the N pieces of the measurement result information from the memory medium.

Step 103: The measurement apparatus increases the first measurement gap period to obtain a target measurement gap period, and measures the target cell based on the target measurement gap period in a case that the N pieces of the measurement result information satisfy a second preset condition.

In the embodiments of this application, the second preset condition may include at least one of the following:
a preset positional relationship is satisfied between the N pieces of location information;
a first preset size relationship is satisfied between the N network signal parameters and a certain threshold (for example, a second threshold in the following embodiment); or
a second preset size relationship is satisfied between a quantity corresponding to the N pieces of the measurement result information and another threshold (for example, a third threshold in the following embodiment).

In the embodiments of this application, if the N pieces of the measurement result information satisfy the second preset condition, it can be determined that the measurement apparatus is located in an area on the edge of the target cell (that is, a network signal of the target cell is poor). Therefore, the measurement apparatus can increase the first measurement gap period.

In the embodiments of this application, the measurement apparatus can increase the first measurement gap period based on a preset multiple, or increase the first measurement gap period based on a preset period.

For example, it is assumed that the first measurement gap period is 40 milliseconds (ms).

The measurement apparatus can increase the first measurement gap period based on a preset multiple (for example, 2 times), that is, the target measurement gap period is: 40*2=80 ms.

In some embodiments, the measurement apparatus can increase the first measurement gap period based on a preset period (for example, 20 ms), that is, the target measurement gap period is: 40+20=60 ms. In the embodiments of this application, if the target measurement gap period is

greater than or equal to a certain preset threshold (for example, a fourth threshold in the following embodiment), the measurement apparatus can determine the certain preset threshold as the target measurement gap period.

It may be understood that the certain preset threshold may be a configurable maximum measurement gap period of the measured target cell. If the target measurement gap period is greater than the maximum measurement gap period, the maximum measurement gap period is used as the target measurement gap period, so that the measurement apparatus can measure the target cell based on the maximum measurement gap period.

In the embodiments of this application, after the measurement apparatus increases the first measurement gap period, the measurement apparatus can interrupt the transmission of the service data performed by using the network of the first cell, and adjust the frequency of the receiver of the measurement apparatus from the frequency of the first cell to the frequency of the target cell to measure the target cell. If the target cell does not satisfy the condition for reporting in the measurement configuration information, the measurement apparatus can restore the frequency of the receiver to the frequency of the first cell and continue to transmit the service data by using the network of the first cell. After the target measurement gap period, the foregoing steps are repeated until a certain cell in the target cell satisfies the condition for reporting.

In the embodiments of this application, in a case that it is determined that the network signal of the target cell is poor, the measurement apparatus can increase the first measurement gap period and measure the target cell based on the target measurement gap period. In this way, in a case that the target cell does not satisfy the condition for reporting in the measurement configuration information, the measurement apparatus can measure the target cell again after a long time.

In the measurement method provided in the embodiments of this application, the measurement apparatus can receive the measurement configuration information sent by the network device, and in a case that the measurement apparatus executes a service by using the network of the first cell and the measurement configuration information satisfies the first preset condition, the measurement apparatus can obtain the N pieces of the measurement result information of the N measurements that have been performed on the target cell corresponding to the measurement configuration information (that is, before the measurement apparatus receives the measurement configuration information). In addition, in a case that the N pieces of the measurement result information satisfy the second preset condition, the measurement apparatus can increase the first measurement gap period in the measurement configuration information to obtain the target measurement gap period, so as to measure the target cell based on the target measurement gap period. In a case that the measurement apparatus can execute a service by using the network of the first cell and the measurement configuration information satisfies the first preset condition, because the measurement apparatus can, based on the measurement configuration information, determine that the measurement apparatus can transmit service data by using the network of the first cell and the network signal of the target cell may be poor, the measurement apparatus can obtain the measurement result information of the N measurements that have been performed on the target cell and determine whether the measurement result information of the N measurements satisfies the second preset condition, so as to determine whether the network signal of the target cell is poor. In addition, in a case that the network signal of the target cell is poor, the measurement apparatus can increase the first measurement gap period and measure the target cell based on the target measurement gap period. In this way, in a case that the target cell does not satisfy the condition for reporting in the measurement configuration information, the measurement apparatus can interrupt the transmission of the service data after the frequency of the receiver is restored to the frequency of the first cell and the service data is transmitted by the network of the first cell for a long time. Therefore, in a case that the network signal of the target cell is poor, time for the measurement apparatus to transmit the service data ca be increased. In this case, the delay for the measurement apparatus to transmit the service data can be reduced.

The following uses an example in which the second preset condition includes: a preset positional relationship is satisfied between the N pieces of location information; a first preset size relationship is satisfied between the N network signal parameters and a certain threshold; and a second preset size relationship is satisfied between a quantity corresponding to the N pieces of the measurement result information and another threshold for description.

In the embodiments of this application, each of the N pieces of the measurement result information includes one piece of location information and one network signal parameter. The one piece of location information is used to indicate a location of the measurement apparatus when one measurement is performed on the target cell, and the one network signal parameter is a network signal parameter of the target cell that is obtained from one measurement that is performed on the target cell. With reference to FIG. 3, as shown in FIG. 4, before the foregoing step 103, the measurement method provided in the embodiments of this application may further include step 201, and step 103 may be implemented by performing the following step 103a.

Step 201: The measurement apparatus determines location change information of the measurement apparatus based on the N pieces of location information.

Further, in the embodiments of this application, the measurement apparatus can determine the first piece of location change information based on the first piece of location information and the second piece of location information, determine the second piece of location change information based on the second piece of location information and the third piece of location information, and determine the third piece of location change information based on the third piece of location information and the fourth piece of location information.

Similar steps are performed until the N−1th piece of location change information is determined based on the N−1th piece of location information and the Nth piece of location information. Then, the measurement can determine the location change information of the measurement apparatus based on N−1 pieces of the location change information. In some embodiments, the measurement apparatus can determine information

of the greatest location change in the N−1 pieces of location change information as the location change information of the measurement apparatus. In some embodiments, the measurement apparatus can determine average location change information of the N−1 pieces of location change information as the location change information of the measurement apparatus.

Step 103a: In a case that the location change information is smaller than or equal to a first threshold, N network signal parameters are all smaller than or equal to a second threshold, and N is greater than or equal to a third threshold, the measurement apparatus increases the first measurement gap period to obtain the target measurement gap period, and measures the target cell based on the target measurement gap period.

Further, in the embodiments of this application, the first threshold (for example, meters), the second threshold, and the third threshold (for example, 3 meters) may all be preset thresholds stored in the memory medium of the measurement apparatus.

In the embodiments of this application, if the location change information is smaller than or equal to the first threshold, the N network signal parameters are all smaller than or equal to the second threshold, and N is greater than or equal to the third threshold, it can be considered that location movement of the measurement apparatus is not significant, the network signal of the target cell is poor, and the measurement apparatus has measured the target cell multiple times. Therefore, the measurement apparatus can increase the first measurement gap period to increase the time for the measurement apparatus to transmit the service data.

It can be learned that the measurement apparatus can determine multiple times whether the network signal of the target cell is poor, and the first measurement gap period is only increased in a case that it is determined that the network signal of the target cell is poor. Therefore, it can be avoided that the measurement apparatus increases the first measurement gap period in a case that the network signal of the target cell is strong, thereby reducing the delay for the measurement apparatus to transmit the service data.

The measurement apparatus can increase the first measurement gap period, and can also reduce a first measurement gap duration in the measurement configuration information to increase the time for the measurement apparatus to transmit the service data in a case that the network signal of the target cell is poor.

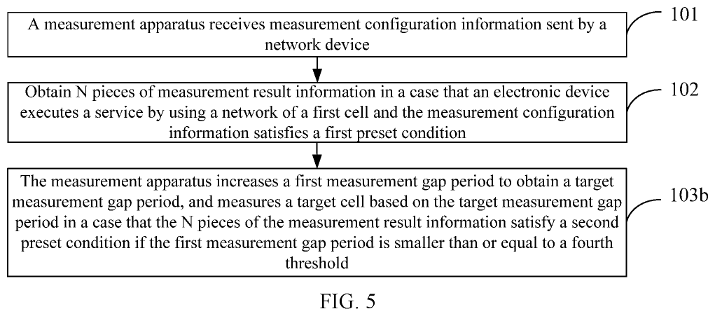

In the embodiments of this application, the measurement configuration information further includes a first measurement gap duration. With reference to FIG. 3, as shown in FIG. 5, the foregoing step 103 may be implemented by performing the following step 103b.

Step 103b: In a case that the N pieces of the measurement result information satisfy the second preset condition, if the first measurement gap period is smaller than or equal to a fourth threshold, the measurement apparatus increases the first measurement gap period to obtain the target measurement gap period, and measure the target cell based on the target measurement gap period.

Further, in the embodiments of this application, the fourth threshold (for example, 160 ms) may be a preset threshold stored in the memory medium of the measurement apparatus.

It may be understood that the fourth threshold is a configurable maximum measurement gap period of the measured target cell.

In the embodiments of this application, if the first measurement gap period is greater than the configurable maximum measurement gap period of the measured target cell, the measurement on the target cell may fail. Therefore, the measurement apparatus can increase the first measurement gap period in a case that the first measurement gap period is smaller than or equal to the configurable maximum measurement gap period.

It can be learned that the measurement apparatus only increases the first measurement gap period in a case that the first measurement gap period is smaller than or equal to the configurable maximum measurement gap period. Therefore, it can be avoided that the measurement on the target cell fails because the target measurement gap period is greater than the configurable maximum measurement gap period of the measured target cell. Therefore, the delay for the measurement apparatus to transmit the service data can be reduced while accuracy of the measurement apparatus performing a measurement is not reduced.

In the embodiments of this application, the foregoing step 103b may be replaced by the following step 301.

Step 301: In a case that the N pieces of the measurement result information satisfy the second preset condition, if the first measurement gap period is greater than the fourth threshold, the measurement apparatus reduces the first measurement gap duration to obtain a target measurement gap duration, and measures the target cell based on the target measurement gap duration.

It may be understood that if the first measurement gap period is greater than the fourth threshold, it can be considered that the first measurement gap period is greater than the configurable maximum measurement gap period of the measured target cell. Therefore, the measurement apparatus can reduce the first measurement gap duration.

It should be noted that the “measurement gap duration” may be understood as a period of time during which the measurement apparatus performs an inter-frequency measurement, and during this period of time, the measurement apparatus can only receive a signal from a corresponding to-be-measured cell and the service data cannot be transmitted.

Further, in the embodiments of this application, the measurement apparatus can reduce the first measurement gap duration based on a preset multiple, or reduce the first measurement gap duration based on a preset duration.

For example, it is assumed that the first measurement gap duration is 6 milliseconds (ms).

The measurement apparatus can reduce the first measurement gap duration based on a preset multiple (for example, ½ times), that is, the target measurement gap duration is: 6*½=3 ms. The measurement apparatus can reduce the first measurement gap duration

based on a preset duration (for example, 2 ms), that is, the target measurement gap duration is 6−2=4 ms.

Further, in the embodiments of this application, in a case that the first measurement gap duration is smaller than a threshold (for example, a fifth threshold in the following embodiment), the measurement apparatus can determine the preset threshold as the target measurement gap duration.

It may be understood that one preset threshold may be a configurable minimum measurement gap duration of the target cell. If the target measurement gap duration is smaller than the minimum measurement gap duration, the minimum measurement gap duration is used as the target measurement gap duration, so that the measurement apparatus can measure the target cell based on the minimum measurement gap duration.

Further, in the embodiments of this application, after the measurement apparatus reduces the first measurement gap duration, the measurement apparatus can interrupt the transmission of the service data by using the network of the first cell, and adjust the frequency of the receiver of the measurement apparatus from the frequency of the first cell to the frequency of the target cell to measure the target measurement gap duration of the target cell. If the target cell does not satisfy the condition for reporting in the measurement configuration information, the measurement apparatus can restore the frequency of the receiver to the frequency of the first cell and continue to transmit the service data by using the network of the first cell. After the first measurement gap period, the foregoing steps are repeated until a certain cell in the target cell satisfies the condition for reporting.

In the embodiments of this application, in a case that it is determined that the network signal of the target cell is poor, the measurement apparatus can reduce the first measurement gap duration and perform a shorter measurement on the target cell. In addition, in a case that the target cell does not satisfy the condition for reporting in the measurement configuration information, the measurement apparatus can perform a shorter measurement again after the first measurement gap period.

It can be learned that the measurement apparatus can reduce the first measurement gap duration in a case that the first measurement gap period is greater than the configurable maximum measurement gap period. Therefore, while it is avoided that the measurement on the target cell fails because the reduced first measurement gap period is greater than the configurable maximum measurement gap period of the measured target cell, time during which the measurement apparatus interrupts the transmission of the service data is reduced. Therefore, the delay for the measurement apparatus to transmit the service data can be reduced while accuracy of the measurement apparatus performing a measurement is not reduced.

In the embodiments of this application, the foregoing step 301 can be implemented by performing the following step 301a.

Step 301a: In a case that the N pieces of the measurement result information satisfy the second preset condition, if the first measurement gap period is greater than the fourth threshold, the measurement apparatus reduces the first measurement gap duration in a case that the first measurement gap duration is greater than or equal to the fifth threshold to obtain a target measurement gap duration, and measures the target cell based on the target measurement gap duration.

Further, in the embodiments of this application, the fifth threshold (for example, 1.5 ms) may be a preset threshold stored in the memory medium of the measurement apparatus.

It may be understood that the fifth threshold is a configurable minimum measurement gap duration of the measured target cell.

In the embodiments of this application, if the first measurement gap duration is smaller than the configurable minimum measurement gap duration of the measured target cell, the measurement on the target cell may fail. Therefore, the measurement apparatus can reduce the first measurement gap duration in a case that the first measurement gap duration is greater than or equal to the configurable minimum measurement gap duration.

It can be learned that the measurement apparatus only reduces the first measurement gap duration in a case that the first measurement gap duration is greater than or equal to the configurable minimum measurement gap duration. Therefore, it can be avoided that the measurement on the target cell fails because the target measurement gap duration is smaller than the configurable minimum measurement gap duration of the measured target cell. Therefore, the delay for the measurement apparatus to transmit the service data can be reduced while accuracy of the measurement apparatus performing a measurement is not reduced.

The measurement apparatus can adjust the measurement gap period (or the measurement gap duration) in the measurement configuration information, and can also prohibit the measurement on the target cell to avoid that the transmission of the service data is interrupted.

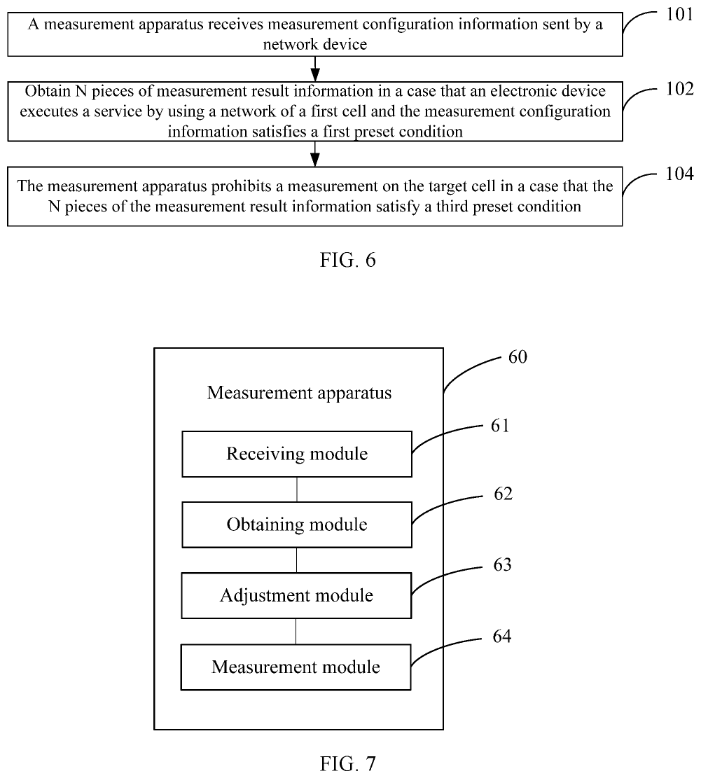

In the embodiments of this application, with reference to FIG. 3, as shown in FIG. 6, after the foregoing step 102, the measurement method provided in the embodiments of this application may further include the following step 104.

Step 104: The measurement apparatus prohibits a measurement on the target cell in a case that the N pieces of the measurement result information satisfy a third preset condition.

It may be understood that the foregoing step 103 may be replaced with step 104.

Further, in the embodiments of this application, the third preset condition may be that the N network signal parameters in the N pieces of the measurement result information are smaller than or equal to a seventh threshold, and N is greater than or equal to an eighth threshold.

Further, in the embodiments of this application, the seventh threshold and the eighth threshold may all be preset thresholds stored in the memory medium of the measurement apparatus.

In the embodiments of this application, if the N pieces of the measurement result information satisfy the third preset condition, it can be considered that the network signal of the target cell is poor, and the measurement apparatus has measured the target cell multiple times. Therefore, the measurement apparatus can prohibit the measurement on the target cell.

It can be learned that because the measurement apparatus can prohibit the measurement on the target cell in a case that the network signal of the target cell is poor and the measurement apparatus has measured the target cell multiple times, that is, the measurement apparatus does not need to adjust the frequency of the receiver from the frequency of the first cell to the frequency of the target cell. Therefore, the measurement apparatus does not need to interrupt the transmission of the service data, thereby reducing the delay for the measurement apparatus to transmit the service data.

It should be noted that an execution subject of the measurement method according to the embodiments of this application may be the measurement apparatus in the foregoing embodiments, or a control module for performing the measurement method in the measurement apparatus. In the embodiments of this application, the measurement apparatus according to the embodiments of this application is described by using an example in which the measurement apparatus performs the measurement method.

FIG. 7 is a possible schematic structural diagram of a measurement apparatus according to the embodiments of this application. As shown in FIG. 7, the measurement apparatus 60 may include a receiving module 61, an obtaining module 62, an adjustment module 63, and a measurement module 64.

The receiving module 61 is configured to receive measurement configuration information sent by a network device, where the measurement configuration information includes a first measurement gap period and an identity of a target cell. The obtaining module 62 is configured to obtain N pieces of measurement result information in a case that the measurement apparatus 60 executes a service by using a network of a first cell and the measurement configuration information received by the receiving module 61 satisfies a first preset condition, where the N pieces of the measurement result information are result information of N measurements performed by the measurement apparatus 60 on the target cell before the measurement configuration information is received, and N is a positive integer. The adjustment module 63 is configured to increase the first measurement gap period to obtain a target measurement gap period in a case that the N pieces of the measurement result information obtained by the obtaining module 62 satisfy a second preset condition. The measurement module 64 is configured to measure the target cell based on the target measurement gap period obtained after the adjustment module 63 increases the first measurement gap period.

In some embodiments, each of the N pieces of the measurement result information includes one piece of location information and one network signal parameter. The one piece of location information is used to indicate a location of the measurement apparatus 60 when one measurement is performed on the target cell, and the one network signal parameter is a network signal parameter of the target cell that is obtained from one measurement that is performed on the target cell. The measurement apparatus 60 provided in the embodiments of this application may further include a determining module. The determining module is configured to determine location change information of the measurement apparatus 60 based on N pieces of location information. The adjustment module 63 is configured to increase the first measurement gap period in a case that the location change information determined by the determining module is smaller than or equal to a first threshold, N network signal parameters are all smaller than or equal to a second threshold, and N is greater than or equal to a third threshold.

In some embodiments, the measurement configuration information further includes a first measurement gap duration. The adjustment module 63 is configured to increase the first measurement gap period in a case that the first measurement gap period is smaller than or equal to a fourth threshold. The adjustment module 63 is further configured to reduce the first measurement gap duration to obtain a target measurement gap duration in a case that the first measurement gap period is greater than the fourth threshold. The measurement module 64 is further configured to measure the target cell based on the target measurement gap duration obtained after the adjustment module 63 reduces the first measurement gap duration.

In some embodiments, the adjustment module 63 is configured to reduce the first measurement gap duration in a case that the first measurement gap duration is greater than or equal to a fifth threshold.

In some embodiments, the measurement apparatus 60 provided in the embodiments of this application further includes a prohibiting module. The prohibiting module is configured to prohibit measurement on the target cell in a case that the N pieces of the measurement result information satisfy a third preset condition.

In the measurement apparatus provided in the embodiments of this application, in a case that the measurement apparatus can execute a service by using the network of the first cell and the measurement configuration information satisfies the first preset condition, because the measurement apparatus can, based on the measurement configuration information, determine that the measurement apparatus can transmit service data by using the network of the first cell and the network signal of the target cell may be poor, the measurement apparatus can obtain the measurement result information of the N measurements that have been performed on the target cell and determine whether the measurement result information of the N measurements satisfies the second preset condition, so as to determine whether the network signal of the target cell is poor. In addition, in a case that the network signal of the target cell is poor, the measurement apparatus can increase the first measurement gap period and measure the target cell based on the target measurement gap period. In this way, in a case that the target cell does not satisfy the condition for reporting in the measurement configuration information, the measurement apparatus can interrupt the transmission of the service data after the frequency of the receiver is restored to the frequency of the first cell and the service data is transmitted by the network of the first cell for a long time. Therefore, in a case that the network signal of the target cell is poor, the measurement apparatus can increase time for the measurement apparatus to transmit the service data. In this case, the delay for the measurement apparatus to transmit the service data can be reduced.

The measurement apparatus in the embodiments of this application may be an apparatus, or a component, an integrated circuit, or a chip in a terminal. The apparatus may be a mobile electronic device or a non-mobile electronic device. For example, the mobile electronic device may be a mobile phone, a tablet computer, a notebook computer, a palmtop computer, a vehicle-mounted terminal, a wearable device, an ultra-mobile personal computer (UMPC), a netbook, a personal digital assistant (PDA), or the like. The non-mobile electronic device may be a server, a network attached storage (NAS), a personal computer (PC), a television (TV), a teller machine, a self-service machine, or the like. This is not specifically limited in the embodiments of this application.

The measurement apparatus in the embodiments of this application may be an apparatus with an operating system. The operating system may be an Android operating system, may be an iOS operating system, or may be another possible operating system, which is not specifically limited in the embodiments of this application.

The measurement apparatus provided in the embodiments of this application can implement the processes implemented in the method embodiments in FIG. 1 to FIG. 6. To avoid repetition, details are not described herein again.

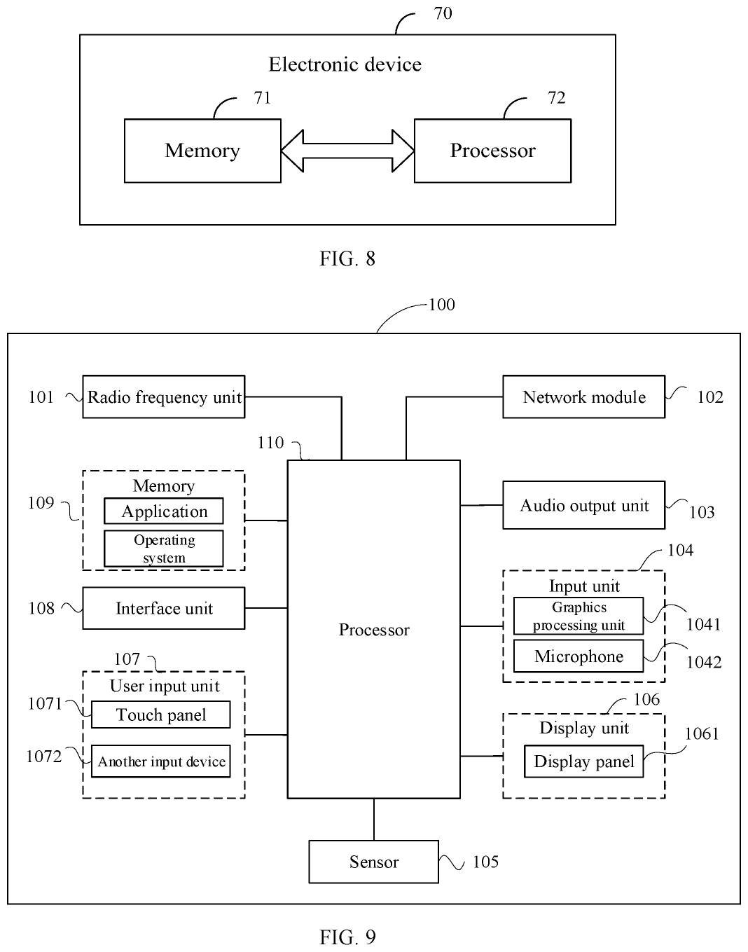

As shown in FIG. 8, an embodiment of this application further provides an electronic device 70, including a processor 72, a memory 71, and a program or an instruction stored in the memory 71 and capable of running on the processor 72. When the program or the instruction is executed by the processor 72, the processes of the foregoing measurement method embodiments are implemented, with the same technical effects achieved. To avoid repetition, details are not described herein again.

It should be noted that the electronic device in the embodiments of this application includes the foregoing mobile electronic device or the non-mobile electronic device.

FIG. 9 is a schematic diagram of a hardware structure of an electronic device according to the embodiments of this application.

The electronic device 100 includes but is not limited to components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the electronic device 100 may further include the power supply (for example, a battery) that supplies power to the components. The power supply may be logically connected to the processor 110 through a power management system, so as to implement functions such as charging management, discharging management, and power consumption management through the power management system. The electronic device is not limited to the electronic device structure shown in FIG. 9. The electronic device may include more or fewer components than those shown in the figure, or combine some of the components, or arrange the components differently.

The radio frequency unit 101 is configured to receive measurement configuration information sent by a network device, where the measurement configuration information includes a first measurement gap period and an identity of a target cell.

The processor 110 is configured to obtain N pieces of measurement result information in a case that an electronic device executes a service by using a network of a first cell and the measurement configuration information satisfies a first preset condition, where the N pieces of the measurement result information are result information of N measurements performed by the electronic device on the target cell before the measurement configuration information is received, and N is a positive integer; increase the first measurement gap period to obtain a target measurement gap period in a case that the N pieces of the measurement result information obtained by the obtaining module satisfy a second preset condition; and measure the target cell based on the target measurement gap duration.

In the electronic device provided in the embodiments of this application, in a case that the electronic device can execute a service by using the network of the first cell and the measurement configuration information satisfies the first preset condition, because the electronic device can, based on the measurement configuration information, determine that the electronic device can transmit service data by using the network of the first cell and the network signal of the target cell may be poor, the electronic device can obtain the measurement result information of the N measurements that have been performed on the target cell and determine whether the measurement result information of the N measurements satisfies the second preset condition, so as to determine whether the network signal of the target cell is poor. In addition, in a case that the network signal of the target cell is poor, the electronic device can increase the first measurement gap period and measure the target cell based on the target measurement gap period. In this way, in a case that the target cell does not satisfy the condition for reporting in the measurement configuration information, the electronic device can interrupt the transmission of the service data after the frequency of the receiver is restored to the frequency of the first cell and the service data is transmitted by the network of the first cell for a long time. Therefore, in a case that the network signal of the target cell is poor, the electronic device can increase time for the electronic device to transmit the service data. In this case, the delay for the electronic device to transmit the service data can be reduced.

In the embodiments of this application, each of the N pieces of the measurement result information includes one piece of location information and a network signal parameter. The one piece of location information is used to indicate a location of the electronic device when one measurement is performed on the target cell, and the network signal parameter is a network signal parameter of the target cell that is obtained from one measurement that is performed on the target cell.

The processor 110 is further configured to determine location change information of the electronic device based on N pieces of location information.

The processor 110 is configured to increase the first measurement gap period in a case that the location change information is smaller than or equal to a first threshold, N network signal parameters are all smaller than or equal to a second threshold, and N is greater than or equal to a third threshold.

It can be learned that the electronic device can determine multiple times whether the network signal of the target cell is poor, and the first measurement gap period is only increased in a case that it is determined that the network signal of the target cell is poor. Therefore, it can be avoided that the electronic device increases the first measurement gap period in a case that the network signal of the target cell is strong, thereby reducing the delay for the electronic device to transmit the service data.

In the embodiments of this application, the measurement configuration information further includes a first measurement gap duration.

The processor 110 is configured to increase the first measurement gap period in a case that the first measurement gap period is smaller than or equal to a fourth threshold.

The processor 110 is configured to reduce the first measurement gap duration to obtain a target measurement gap duration, and measure the target cell based on the target measurement gap duration in a case that the first measurement gap period is greater than the fourth threshold.

It can be learned that the electronic device only reduces the first measurement gap period in a case that the first measurement gap period is smaller than or equal to the configurable maximum measurement gap period. Therefore, it can be avoided that the measurement on the target cell fails because the target measurement gap period is greater than the configurable maximum measurement gap period of the measured target cell. Therefore, the delay for the electronic device to transmit the service data can be reduced while accuracy of the electronic device performing a measurement is not reduced.

It can be learned that the electronic device can reduce the first measurement gap duration in a case that the first measurement gap period is greater than the configurable maximum measurement gap period. Therefore, while it is avoided that the measurement on the target cell fails because the target measurement gap period is greater than the configurable maximum measurement gap period of the measured target cell, time during which the electronic device interrupts the transmission of the service data is reduced. Therefore, the delay for the electronic device to transmit the service data can be reduced while accuracy of the electronic device performing a measurement is not reduced.

In the embodiments of this application, the processor 110 is configured to reduce the first measurement gap duration in a case that the first measurement gap duration is greater than or equal to a fifth threshold.

It can be learned that the electronic device only reduces the first measurement gap duration in a case that the first measurement gap duration is greater than or equal to the configurable minimum measurement gap duration. Therefore, it can be avoided that the measurement on the target cell fails because the target measurement gap duration is smaller than the configurable minimum measurement gap duration of the measured target cell. Therefore, the delay for the electronic device to transmit the service data can be reduced while accuracy of the electronic device performing a measurement is not reduced.

In the embodiments of this application, the processor 110 is configured to prohibit measurement on the target cell in a case that the N pieces of the measurement result information satisfy a third preset condition.

It can be learned that because the electronic device can prohibit the measurement on the target cell in a case that the network signal of the target cell is poor and the electronic device has measured the target cell multiple times, that is, the electronic device does not need to adjust the frequency of the receiver from the frequency of the first cell to the frequency of the target cell. Therefore, the electronic device does not need to interrupt the transmission of the service data, thereby reducing the delay for the electronic device to transmit the service data.

It should be understood that, in the embodiments of this application, the input unit 104 may include a graphics processing unit (GPU) 1041 and a microphone 1042, and the graphics processing unit 1041 processes image data of a still picture or video obtained by an image capture apparatus (such as a camera) in a video capture mode or an image capture mode. The display unit 106 may include the display panel 1061. The display panel 1061 may be configured in a form of a liquid crystal display, an organic light-emitting diode, or the like. The user input unit 107 includes a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein. The memory 109 may be configured to store a software program and various data, including but not limited to an application and an operating system. An application processor and a modem processor may be integrated into the processor 110, the application processor mainly processes an operating system, a user interface, an application, and the like, and the modem processor mainly processes wireless communication. It can be understood that the modem processor may be not integrated in the processor 110.

An embodiment of this application further provides a readable storage medium. The readable storage medium stores a program or an instruction. When the program or the instruction is executed by a processor, the processes in the foregoing measurement method embodiments are implemented, with the same technical effect achieved. To avoid repetition, details are not described herein again.

The processor is a processor in the electronic device in the foregoing embodiment. The readable storage medium includes a computer-readable storage medium such as a computer read-only memory (ROM), a random access memory (RAM), a magnetic disk, or an optical disc.

An embodiment of this application further provides a chip. The chip includes a processor and a communications interface, and the communications interface is coupled to the processor. The processor is configured to run a program or an instruction, to implement various processes of the foregoing measurement method embodiments, with the same technical effects achieved. To avoid repetition, details are not described herein again.

It should be understood that the chip mentioned in this embodiment of the present application may also be referred to as a system-level chip, a system chip, a system on chip, a system chip on chip, and the like.

It should be noted that in this specification, the terms “include” and “comprise”, or any of their variants are intended to cover a non-exclusive inclusion, such that a process, a method, an article, or an apparatus that includes a list of elements not only includes those elements but also includes other elements that are not expressly listed, or further includes elements inherent to such a process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of the present application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

According to the description of the foregoing embodiments, persons skilled in the art can clearly understand that the method in the foregoing embodiments may be implemented by software in addition to a necessary universal hardware platform or by hardware only. Based on such an understanding, the technical solutions of this application essentially, or the part contributing to the prior art may be implemented in a form of a software product. The software product is stored in a storage medium (for example, ROM/RAM, a magnetic disk, or an optical disc), and includes several instructions for instructing a terminal (which may be a mobile phone, a computer, a server, an air conditioner, a network device, or the like) to perform the method described in the embodiments of the present application.

The embodiments of this application are described above with reference to the accompanying drawings, but this application is not limited to the above implementations, and the above implementations are only illustrative and not restrictive. Enlightened by this application, a person of ordinary skill in the art can make many forms without departing from the purpose of this application and the protection scope of the claims, all of which shall fall within the protection of this application.

What is claimed is:

1. A measurement method, comprising:
receiving measurement configuration information sent by a network device, wherein the measurement configuration information comprises a first measurement gap period and an identity of a target cell;
obtaining N pieces of measurement result information when an electronic device executes a service by using a network of a first cell and the measurement configuration information satisfies a first preset condition, wherein the N pieces of the measurement result information are result information of N measurements performed by the electronic device on the target cell before the measurement configuration information is received, and N is a positive integer; and
increasing the first measurement gap period to obtain a target measurement gap period, and measuring the target cell based on the target measurement gap period when the N pieces of the measurement result information satisfy a second preset condition.

2. The measurement method according to claim 1, wherein each of the N pieces of the measurement result information comprises one piece of location information and a network signal parameter, the one piece of location information is used to indicate a location of the electronic device when one measurement is performed on the target cell, and the network signal parameter is a network signal parameter of the target cell that is obtained from one measurement that is performed on the target cell;
before the increasing the first measurement gap period when the N pieces of the measurement result information satisfy a second preset condition, the measurement method further comprises:
determining location change information of the electronic device based on N pieces of location information; and
the increasing the first measurement gap period when the N pieces of the measurement result information satisfy a second preset condition comprises:
increasing the first measurement gap period when the location change information is smaller than or equal to a first threshold, N network signal parameters are all smaller than or equal to a second threshold, and N is greater than or equal to a third threshold.

3. The measurement method according to claim 1, wherein the measurement configuration information further comprises a first measurement gap duration;
the increasing the first measurement gap period comprises:
increasing the first measurement gap period when the first measurement gap period is smaller than or equal to a fourth threshold; and
the measurement method further comprises:
when the first measurement gap period is greater than the fourth threshold, reducing the first measurement gap duration to obtain a target measurement gap duration, and measuring the target cell based on the target measurement gap duration.

4. The measurement method according to claim 3, wherein the reducing the first measurement gap duration comprises:
reducing the first measurement gap duration when the first measurement gap duration is greater than or equal to a fifth threshold.

5. The measurement method according to claim 1, wherein after the obtaining N pieces of measurement result information, the measurement method further comprises:
prohibiting measurement on the target cell when the N pieces of the measurement result information satisfy a third preset condition.

6. An electronic device, comprising a memory storing a computer program; and a processor coupled to the memory and configured to execute the computer program to perform operations comprising:
receiving measurement configuration information sent by a network device, wherein the measurement configuration information comprises a first measurement gap period and an identity of a target cell;
obtaining N pieces of measurement result information when the electronic device executes a service by using a network of a first cell and the measurement configuration information satisfies a first preset condition, wherein the N pieces of the measurement result information are result information of N measurements performed by the electronic device on the target cell before the measurement configuration information is received, and N is a positive integer; and
increasing the first measurement gap period to obtain a target measurement gap period, and measuring the target cell based on the target measurement gap period when the N pieces of the measurement result information satisfy a second preset condition.

7. The electronic device according to claim 6, wherein each of the N pieces of the measurement result information comprises one piece of location information and a network signal parameter, the one piece of location information is used to indicate a location of the electronic device when one measurement is performed on the target cell, and the network signal parameter is a network signal parameter of the target cell that is obtained from one measurement that is performed on the target cell;
before the increasing the first measurement gap period when the N pieces of the measurement result information satisfy a second preset condition, the operations further comprise:
determining location change information of the electronic device based on N pieces of location information; and
the increasing the first measurement gap period when the N pieces of the measurement result information satisfy a second preset condition comprises:
increasing the first measurement gap period when the location change information is smaller than or equal to a first threshold, N network signal parameters are all smaller than or equal to a second threshold, and N is greater than or equal to a third threshold.

8. The electronic device according to claim 6, wherein the measurement configuration information further comprises a first measurement gap duration;
the increasing the first measurement gap period comprises:
increasing the first measurement gap period when the first measurement gap period is smaller than or equal to a fourth threshold; and
the operations further comprise:
when the first measurement gap period is greater than the fourth threshold, reducing the first measurement gap duration to obtain a target measurement gap duration, and measuring the target cell based on the target measurement gap duration.

9. The electronic device according to claim 8, wherein the reducing the first measurement gap duration comprises:
reducing the first measurement gap duration when the first measurement gap duration is greater than or equal to a fifth threshold.

10. The electronic device according to claim 6, wherein after the obtaining N pieces of measurement result information, the operations further comprise:
prohibiting measurement on the target cell when the N pieces of the measurement result information satisfy a third preset condition.

11. A non-transitory computer-readable storage medium, storing a computer program, when the computer program is executed by a processor, causes the processor to perform operations comprising:
receiving measurement configuration information sent by a network device, wherein the measurement configuration information comprises a first measurement gap period and an identity of a target cell;
obtaining N pieces of measurement result information when an electronic device executes a service by using a network of a first cell and the measurement configuration information satisfies a first preset condition, wherein the N pieces of the measurement result information are result information of N measurements performed by the electronic device on the target cell before the measurement configuration information is received, and N is a positive integer; and
increasing the first measurement gap period to obtain a target measurement gap period, and measuring the target cell based on the target measurement gap period when the N pieces of the measurement result information satisfy a second preset condition.

12. The non-transitory computer-readable storage medium according to claim 11, wherein each of the N pieces of the measurement result information comprises one piece of location information and a network signal parameter, the one piece of location information is used to indicate a location of the electronic device when one measurement is performed on the target cell, and the network signal parameter is a network signal parameter of the target cell that is obtained from one measurement that is performed on the target cell;
before the increasing the first measurement gap period when the N pieces of the measurement result information satisfy a second preset condition, the operations further comprise:
determining location change information of the electronic device based on N pieces of location information; and
the increasing the first measurement gap period when the N pieces of the measurement result information satisfy a second preset condition comprises:
increasing the first measurement gap period when the location change information is smaller than or equal to a first threshold, N network signal parameters are all smaller than or equal to a second threshold, and N is greater than or equal to a third threshold.

13. The non-transitory computer-readable storage medium according to claim 11, wherein the measurement configuration information further comprises a first measurement gap duration;
the increasing the first measurement gap period comprises:
increasing the first measurement gap period when the first measurement gap period is smaller than or equal to a fourth threshold; and
the operations further comprise:
when the first measurement gap period is greater than the fourth threshold, reducing the first measurement gap duration to obtain a target measurement gap duration, and measuring the target cell based on the target measurement gap duration.

14. The non-transitory computer-readable storage medium according to claim 13, wherein the reducing the first measurement gap duration comprises:
reducing the first measurement gap duration when the first measurement gap duration is greater than or equal to a fifth threshold.

15. The non-transitory computer-readable storage medium according to claim 11, wherein after the obtaining N pieces of measurement result information, the operations further comprise:
prohibiting measurement on the target cell when the N pieces of the measurement result information satisfy a third preset condition.
